(19) United States
(12) Patent Application Publication
(10) Pub. No.: US 2010/0232536 A1
(43) Pub. Date: Sep. 16, 2010

(54) PRECODING APPARATUS FOR MULTI-USER, MULTI-ANTENNA, WIRELESS TRANSMISSION SYSTEM

(75) Inventors: Kyoung-min PARK, Goyang-si (KR); Sung-jin Suh, Seoul (KR); Sung-jun Yoon, Seoul (KR); Myung-cheul Jung, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/723,260

(22) Filed: Mar. 12, 2010

(30) Foreign Application Priority Data
Mar. 16, 2009 (KR) 10-2009-22358

(51) Int. Cl. H04B 7/02; H04L 25/03

(52) U.S. Cl. 375/267; 375/296

(57) ABSTRACT

A multi-antenna wireless transmission apparatus for multiple receiving terminals includes a channel characteristic acquiring unit to acquire characteristic parameters of a wireless transmission channel between a transmitting party antenna and a receiving party antenna, a coefficient calculator to use the characteristic parameters of the wireless transmission channel to calculate coefficients configured such that the transmitting party sets a ratio of received power for a transmission signal at the receiving party to intensity of interference and noise of the transmission signal, and a precoder to multiply an input signal by a matrix whose elements are the coefficients calculated by the coefficient calculator and to output an output signal. The output signal is to be transmitted from the transmitting party antenna to the receiving party antenna.

### CROSS-REFERENCE TO RELATED APPLICATION

This application claims priority from and the benefit of Korean Patent Application No. 10-2009-22358, filed on Mar. 16, 2009, which is hereby incorporated by reference for all purposes as if fully set forth herein.

### BACKGROUND

1. Field of the Invention

Embodiments of the present invention relate to wireless transmission technology using multiple antennas, and more particularly, to precoding technology that may be applied in a multi-user, multi-antenna, wireless transmission system.

2. Discussion Of the Background

To make more efficient use of a limited frequency band, Multiple-Input and Multiple-Output (MIMO) technology using multiple antennas has been developed. The MIMO technology incorporates space-time coding. The space-time coding is signal pre-processing to transmit input signals in an overlapping fashion or to temporally and spatially divide and transmit input signals through multiple antennas.

In the MIMO technology, a spatial diversity scheme transmits information through multiple antennas in an overlapping fashion, and a spatial multiplexing scheme expands channels by dividing and transmitting separate information through multiple antennas.

The following description relates to precoding technology for supporting Multi-User Multiple-Input and Multiple-Output (MU-MIMO) transmission by which a transmitting terminal transmits information to multiple users through multiple antennas and each user receives signals through at least a single antenna.

Generally, MU-MIMO transmission contributes to an increase in a system transmission capacity and more effective bandwidth allocation. However, if multiple antennas are not used at a receiving terminal, the reception and decoding performance of signals may not be ensured due to interference between signals.

FIG. 1 shows an exemplary Multiple-Input and Multiple-Output (MIMO) system for transmitting information to two users having single antennas through two transmission antennas. In FIG. 1, s₀ and s₁ represent signals to be transmitted through the two antennas, h₀ through h₃ represent fading characteristic parameters, and r₀ and r₁ represent signals received by the users. Also, solid lines connecting the antennas represent paths for information transmission to intended users, and dotted lines between the antennas represent paths through which information is transmitted to unintended users due to interference.

In the MIMO system shown in FIG. 1, each user also receives signals intended to be transferred to a different user. If the unintended signals are received in relatively great values, it may be more difficult to restore desired information. In this example, the received signals r₀ and r₁ may be expressed as the following equation.

$$( \begin{matrix}{r}_{0} \\ {r}_{1}\end{matrix} ) = ( \begin{matrix}{h}_{0} & {h}_{1} \\ {h}_{2} & {h}_{3}\end{matrix} ) ( \begin{matrix}{s}_{0} \\ {s}_{1}\end{matrix} ) + ( \begin{matrix}{η}_{0} \\ {η}_{1}\end{matrix} ) = ( \begin{matrix}{h}_{0} {s}_{0} + {h}_{1} {s}_{1} \\ {h}_{2} {s}_{0} + {h}_{3} {s}_{1}\end{matrix} ) + ( \begin{matrix}{η}_{0} \\ {η}_{1}\end{matrix} )$$

In the equation, if h₀ and h₃ are significantly greater than h₂ or h₁ information transmission may be more effectively performed. But if h₀ and h₃ are not significantly greater than h₂ or h₁, decoding performance may deteriorate due to interference.

FIG. 2 shows an example of information being transmitted to two users through beam forming. In FIG. 2, dotted lines show the contours of formed beams. In this example, the users are identified by the direction of signal transmission. When users are located in different directions from a transmitting terminal, more effective information transmission is possible, but if users are located in the same direction or in similar directions, as shown in FIG. 2, interference between signals still may occur, which can lower the restoration performance of received signals.

### SUMMARY

Exemplary embodiments of the present invention provide a precoder which may be adaptable to varying channel states, and by which signal reception performance can be provided to users when signals are transmitted through multiple antennas.

Additional features of the invention will be set forth in the description which follows, and in part will be apparent from the description, or may be learned by practice of the invention.

An exemplary embodiment of the present invention discloses a precoder for a wireless transmission terminal based on a Multiple-Input and Multiple-Output (MIMO) scheme, the precoder to multiply an input signal by a matrix, and to output the product for wireless transmission, the precoder matrix having coefficients configured such that a transmitting party sets a ratio of received power for a transmission signal at a receiving party to intensity of interference and noise of the transmission signal.

An exemplary embodiment of the present invention discloses a multi-antenna, wireless transmission apparatus, including a channel characteristic acquiring unit to acquire characteristic parameters of a wireless transmission channel between a transmitting party antenna and a receiving party antenna, a coefficient calculator to use the characteristic parameters of the wireless transmission channel to calculate coefficients configured such that the transmitting party sets a ratio of received power for a transmission signal at the receiving party to intensity of interference and noise of the transmission signal; and a precoder to multiply an input signal by a matrix whose elements are the coefficients calculated by the coefficient calculator, and to output the product for transmission to the receiving party antenna.

An exemplary embodiment of the present invention discloses a method for transmitting a transmission signal from a wireless transmission terminal based on a Multiple-Input and Multiple-Output (MIMO) scheme. The method includes acquiring characteristic parameters of a transmission channel between a transmitting party antenna and a receiving party antenna, calculating coefficients configured such that a transmitting party sets a ratio of received power for a transmission signal at a receiving party to intensity of interference and noise of the transmission signal, multiplying an input signal by a matrix whose elements are the coefficients to generate an output signal, and outputting the output signal for transmission from the transmitting party antenna to the receiving party antenna.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an exemplary Multiple-Input and Multiple-Output (MIMO) system for transmitting information to two users through two transmission antennas.

FIG. 2 shows an example of information being transmitted to two users through beam forming.

FIG. 3 shows a multi-user, multi-antenna, wireless transmission/reception system including a precoder according to an exemplary embodiment.

FIG. 4 shows a precoding matrix that is used in a 2×2 MU-MIMO system according to an exemplary embodiment.

FIG. 5 is a detailed view of the multi-user, multi-antenna, wireless to transmission/reception system including the precoder according to an exemplary embodiment.

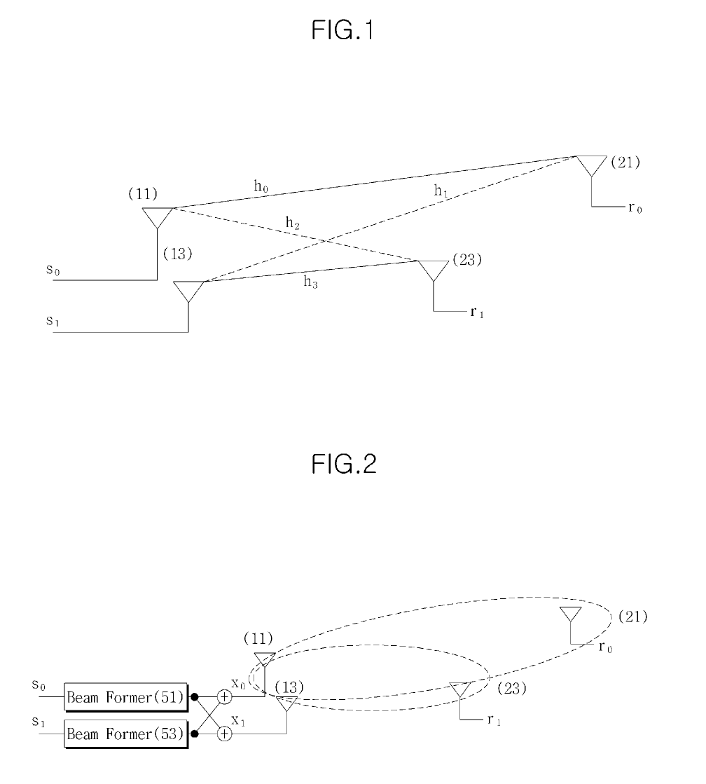

### DETAILED DESCRIPTION OF THE ILLUSTRATED EMBODIMENTS

Exemplary embodiments now will be described more fully hereinafter with reference to the accompanying drawings, in which exemplary embodiments are shown. This is disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

When a precoder is used, a reception Signal to Interference and Noise Ratios (SINR) at a receiving terminal is in a complex form that is not easily analyzed. Thus, if a receiving terminal has to process a precoding matrix configured to set or maximize SINR, the calculations are complicated since the elements of the precoding matrix may be non-differentiable with respect to channel characteristic parameters.

According to an exemplary embodiment, a transmitting party can calculate a precoding matrix configured to set a ratio of received power for a transmission signal to intensity of interference and noise of the transmission signal, which provides a closed form solution, thus enabling a response under varying channel states. More specifically, the transmitting party can calculate a precoding matrix configured to maximize the ratio according to certain assumptions. By introducing this concept of a transmission SINR, a precoder on the transmission side may be configured to modify a reception SINR to a simplest form through sequential optimization and then set the reception SINR through phased optimization.

The following description relates to a precoder designed to set an average of SINR of signals received by receiving terminals under the assumption that users should receive a constant reception SINR.

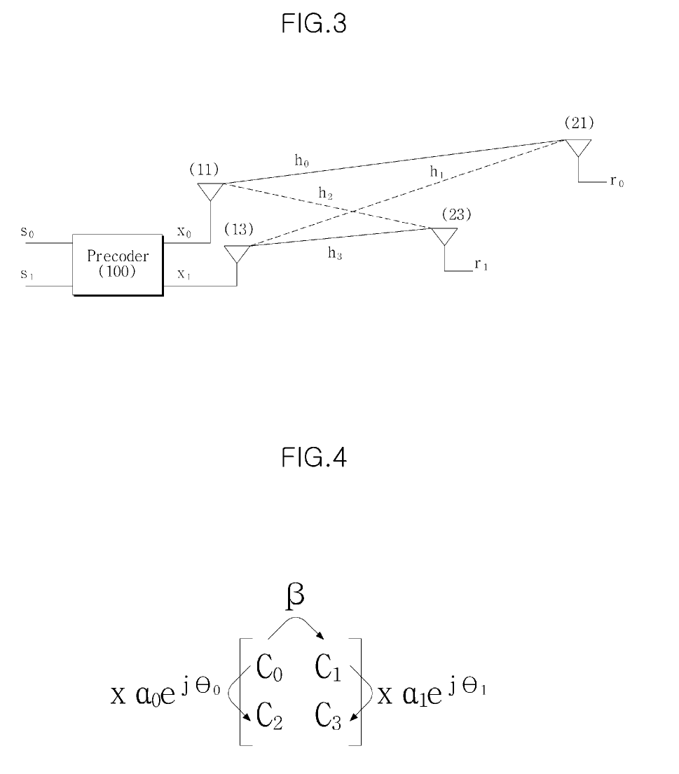

FIG. 3 shows a multi-user, multi-antenna, wireless transmission/reception system including a precoder 100 according to an exemplary embodiment. The precoder 100 for a wireless transmission terminal based on a Multi-User Multiple-Input and Multiple-Output (MU-MIMO) scheme has coefficients configured such that a transmitting party sets a ratio of received power for a transmission signal at a receiving party to intensity of interference and noise of the transmission signal. In FIG. 3, s₀ and s₁ represent signals to be transmitted (also, referred to as transmission signals), h₀ through h₃ represent fading characteristic parameters of respective channels, and r₀ and r₁ represent signals received by receiving terminals. Also, in FIG. 3, solid lines connecting antennas represent intended paths for information transmission, and dotted lines between the antennas represent paths in which interference occurs.

Referring to FIG. 3, when the precoder 100 coefficient matrix is expressed by a matrix C, the transmission and reception relation may be expressed as follows:

$$\begin{matrix}\begin{matrix}R & = & H & C & S & + & N \\ ( \begin{matrix}{r}_{0} \\ {r}_{1}\end{matrix} ) & = & ( \begin{matrix}{h}_{0} & {h}_{1} \\ {h}_{2} & {h}_{3}\end{matrix} ) & ( \begin{matrix}{c}_{0} & {c}_{1} \\ {c}_{2} & {c}_{3}\end{matrix} ) & ( \begin{matrix}{s}_{0} \\ {s}_{1}\end{matrix} ) & + & ( \begin{matrix}{η}_{0} \\ {η}_{1}\end{matrix} )\end{matrix} \\ or & ( 1 ) \\ ( \begin{matrix}{r}_{0} \\ {r}_{1}\end{matrix} ) = ( \begin{matrix}{h}_{0} {c}_{0} + {h}_{1} {c}_{2} & {h}_{0} {c}_{1} + {h}_{1} {c}_{3} \\ {h}_{2} {c}_{0} + {h}_{3} {c}_{2} & {h}_{2} {c}_{1} + {h}_{3} {c}_{3}\end{matrix} ) ( \begin{matrix}{s}_{0} \\ {s}_{1}\end{matrix} ) + ( \begin{matrix}{η}_{0} \\ {η}_{1}\end{matrix} ) & ( 2 )\end{matrix}$$

Here, η₀ and η₁ are noise components.

In this case, SINRs of signals received by receiving terminals may be expressed as follows.

$${SINR}_{0} = \frac{( {h}_{0} {c}_{0} + {h}_{1} {c}_{2} ) {( {h}_{0} {c}_{0} + {h}_{1} {c}_{2} )}^{*}}{( {h}_{0} {c}_{1} + {h}_{1} {c}_{3} + {η}_{0} ) {( {h}_{0} {c}_{1} + {h}_{1} {c}_{3} + {η}_{0} )}^{*}} \\ {SINR}_{1} = \frac{( {h}_{2} {c}_{1} + {h}_{3} {c}_{3} ) {( {h}_{2} {c}_{1} + {h}_{3} {c}_{3} )}^{*}}{( {h}_{2} {c}_{0} + {h}_{3} {c}_{2} + {η}_{1} ) {( {h}_{2} {c}_{0} + {h}_{3} {c}_{2} + {η}_{1} )}^{*}} \qquad ( 3 )$$

The above equations may be rewritten by applying an average SINR, below.

$${SINR}_{0} = \frac{( {h}_{0} {c}_{0} + {h}_{1} {c}_{2} ) {( {h}_{0} {c}_{0} + {h}_{1} {c}_{2} )}^{*}}{( {h}_{0} {c}_{1} + {h}_{1} {c}_{3} ) {( {h}_{0} {c}_{1} + {h}_{1} {c}_{3} )}^{*} + {σ}_{0}^{2}} \\ {SINR}_{1} = \frac{( {h}_{2} {c}_{1} + {h}_{3} {h}_{3} ) {( {h}_{2} {c}_{1} + {h}_{3} {c}_{3} )}^{*}}{( {h}_{2} {c}_{0} + {h}_{3} {c}_{2} ) {( {h}_{2} {c}_{0} + {h}_{3} {c}_{2} )}^{*} + {σ}_{1}^{2}} \qquad ( 4 )$$

Here, σₙ² represents noise of a received signal at a receiving terminal n.

Since the SINRs (SINR₀ and SINR₁), which are reception SINRs of the receiving terminals, are given as functions including four complex variables and are non-differentiable with respect to c₀ through c₃, values of c₀ through c₃ to achieve a desired SINR can be calculated through complex calculations. Such calculations may be very difficult or time-consuming.

The current embodiment discloses a method for calculating, in the form of a closed-form solution, precodes configured to set a reception SINR. A precoder implementing such precodes may be more adaptable to varying channel states.

In the current embodiment, a transmission SINR is defined in the following equation.

$${SINR}_{n}^{tx} = \frac{Recieved Power of {s}_{n}}{Intensity of Interference and Noise of {s}_{n}} \qquad ( 5 )$$

Hence, the transmission SINRs may be expressed as follows.

$$\begin{matrix}{SINR}_{0}^{tx} = E [ \frac{( {h}_{0} {c}_{0} + {h}_{1} {c}_{2} ) {( {h}_{0} {c}_{0} + {h}_{1} {c}_{2} )}^{*}}{( {h}_{2} {c}_{0} + {h}_{3} {c}_{2} + {η}_{1} ) {( {h}_{2} {c}_{0} + {h}_{3} {c}_{2} + {η}_{1} )}^{*}} ] \\ = \frac{( {h}_{0} {c}_{0} + {h}_{1} {c}_{2} ) {( {h}_{0} {c}_{0} + {h}_{1} {c}_{2} )}^{*}}{( {h}_{2} {c}_{0} + {h}_{3} {c}_{2} ) {( {h}_{2} {c}_{0} + {h}_{3} {c}_{2} )}^{*} + {σ}_{1}^{2}}\end{matrix} \\ \begin{matrix}{SINR}_{1}^{tx} = E [ \frac{( {h}_{2} {c}_{1} + {h}_{3} {c}_{3} ) {( {h}_{2} {c}_{1} + {h}_{3} {c}_{3} )}^{*}}{( {h}_{0} {c}_{1} + {h}_{1} {c}_{3} + {η}_{0} ) {( {h}_{0} {c}_{1} + {h}_{1} {c}_{3} + {η}_{0} )}^{*}} ] \\ = \frac{( {h}_{2} {c}_{1} + {h}_{3} {c}_{3} ) {( {h}_{2} {c}_{1} + {h}_{3} {c}_{3} )}^{*}}{( {h}_{0} {c}_{1} + {h}_{1} {c}_{3} ) {( {h}_{0} {c}_{1} + {h}_{1} {c}_{3} )}^{*} + {σ}_{0}^{2}}\end{matrix} \qquad ( 6 )$$

If reception SINRs are expressed as:

$${SINR}_{0} = \frac{B}{A} , {SINR}_{1} = \frac{D}{C} , \qquad ( 7 )$$

the transmission SINRs may be defined as follows.

$${SINR}_{0}^{tx} = \frac{B}{C} , {SINR}_{1}^{tx} = \frac{D}{A} \qquad ( 8 )$$

In this case, transmission control is made to satisfy

$${SINR}_{0} = \frac{B}{A} = {SINR}_{1} = \frac{D}{C} .$$

### Since

$$\frac{B}{A} + \frac{D}{C} = 2 \sqrt{\frac{BD}{AC}} ,$$

by minimizing the transmission SINRs given as

$${SINR}_{0}^{tx} = \frac{B}{C} and {SINR}_{1}^{tx} = \frac{D}{A} ,$$

c₀ through c₃ values for satisfying

$$\frac{B}{A} = \frac{D}{C}$$

and maximizing

$$\frac{B}{A} + \frac{D}{C}$$

may be calculated.

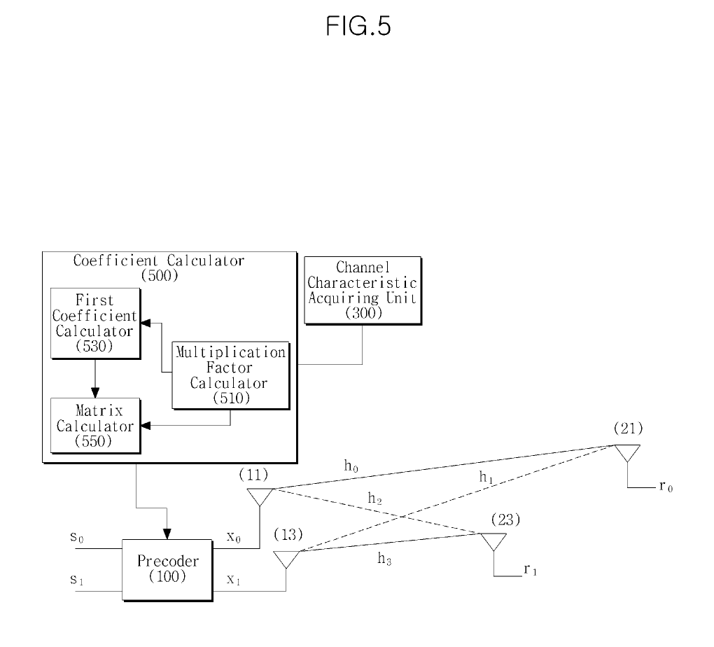

FIG. 4 is a view for explaining a method for calculating coefficients of a precoding matrix that is used in a 2×2 MU-MIMO system. In this example, the first step may be to calculate a value of c₀, a second step may be to multiply the c₀ value by an inter-column multiplication factor β. The third step may be to multiply the c₀ value and the product of the second step by a first inter-row multiplication factor α₀ e^{jθ0} and a second inter-row multiplication factor α₁e^{jθ1} to determine the third and fourth coefficients c₂ and c₃, respectively. The fourth coefficient c₃ may be determined by means of multiplying the c₀ value by an inter-row multiplication factor α₀e^{jθ0} and an inter-column multiplication factor β in order. Since the multiplication factors are implemented in the form of closed-form solutions for channel parameters, the coefficients cₙ of the precoding matrix may be more easily calculated.

By applying the precoding matrix shown in FIG. 4, the transmission SINRs may be defined with trigonometric functions as shown here.

$${SINR}_{0}^{tx} = \frac{\begin{matrix}2 Re ( {h}_{0}^{*} {h}_{1} ) {α}_{0} cos {θ}_{0} + \\ 2 Im ( {h}_{0}^{*} {h}_{1} ) {α}_{0} sin {θ}_{0} + {α}_{0}^{2} {h}_{3} {h}_{3}^{*} + {h}_{0} {h}_{0}^{*}\end{matrix}}{\begin{matrix}2 Re ( {h}_{2}^{*} {h}_{3} ) {α}_{0} cos {θ}_{0} + 2 Im ( {h}_{2}^{*} {h}_{3} ) {α}_{0} sin {θ}_{0} + \\ {α}_{0}^{2} {h}_{3} {h}_{3}^{*} + {σ}_{1}^{2} ( 1 + {α}_{0}^{2} ) + {h}_{2} {h}_{2}^{*}\end{matrix}} \\ {SINR}_{1}^{tx} = \frac{\begin{matrix}2 Re ( {h}_{2}^{*} {h}_{3} ) {α}_{1} cos {θ}_{1} + \\ 2 Im ( {h}_{2}^{*} {h}_{3} ) {α}_{1} sin {θ}_{1} + {α}_{1}^{2} {h}_{3} {h}_{3}^{*} + {h}_{2} {h}_{2}^{*}\end{matrix}}{\begin{matrix}2 Re ( {h}_{0}^{*} {h}_{1} ) {α}_{1} cos {θ}_{1} + 2 Im ( {h}_{0}^{*} {h}_{1} ) {α}_{1} sin {θ}_{1} + \\ {α}_{1}^{2} {h}_{1} {h}_{1}^{*} + {σ}_{0}^{2} ( 1 + {α}_{1}^{2} ) + {h}_{0} {h}_{0}^{*}\end{matrix}} \qquad ( 9 )$$

The above equations are differentiable with respect to αₙ and θₙ. By partially differentiating SINR₀^{tx} and SINR₁^{tx} with respect to each of αₙ and θₙ, the maximums of SINR₀^{tx} and SINR₁^{tx} may be calculated.

Also, the above variables are given in closed forms below.

H₀=h₀h₀* H₁=h₃h₃*+σ₁² H₂=σ₁²+h₂h₂* H₃=h₃h₃*

J₀=h₂h₂* J₁=h₁h₁*+σ₀² J₂=σ₀²+h₀h₀* J₃=h₁h₁* (10)

If SINR₀^{tx} and SINR₁^{tx} are partially differentiated with respect to αₙ and θₙ, values of αₙ and θₙ that maximize the transmission SINRs according to certain assumptions may be calculated below.

$$\begin{matrix}{a}_{0} = \sqrt{\frac{( {h}_{2}^{*} {h}_{3} {H}_{0} - {h}_{0}^{*} {h}_{1} {H}_{2} ) ( 1 - C )}{( {h}_{2}^{*} {h}_{3} {H}_{3} - {h}_{0}^{*} {h}_{1} {H}_{1} ) ( 1 + C )}} & C = \frac{{H}_{2} {H}_{3} - {H}_{3}^{2} - {σ}_{1}^{2} {H}_{0}}{2 Im ( {h}_{0}^{*} {h}_{1} {h}_{2} {h}_{3}^{*} )} \\ {a}_{1} = \sqrt{\frac{( {h}_{0}^{*} {h}_{1} {J}_{0} - {h}_{2}^{*} {h}_{3} {J}_{2} ) ( 1 - T )}{( {h}_{0}^{*} {h}_{1} {J}_{3} - {h}_{2}^{*} {h}_{3} {J}_{1} ) ( 1 + T )}} & T = \frac{{J}_{2} {J}_{3} - {J}_{3}^{2} - {σ}_{0}^{2} {J}_{0}}{2 Im ( {h}_{0}^{*} {h}_{1} {h}_{2} {h}_{3}^{*} )}\end{matrix} \\ {θ}_{0} = {sin}^{- 1} ( \frac{2 {α}_{0} Im ( {h}_{0}^{*} {h}_{1} {h}_{2} {h}_{3}^{*} )}{\vert \begin{matrix}{h}_{0}^{*} {h}_{1} ( \begin{matrix}{α}_{0}^{2} {H}_{1} + \\ {H}_{2}\end{matrix} ) - \\ {h}_{2}^{*} {h}_{3} ( \begin{matrix}{α}_{0}^{2} {H}_{3} + \\ {H}_{0}\end{matrix} )\end{matrix} \vert} ) - φ ( \begin{matrix}{h}_{0}^{*} {h}_{1} ( {α}_{0}^{2} {H}_{1} + {H}_{2} ) - \\ {h}_{2}^{*} {h}_{3} ( {a}_{0}^{2} {H}_{3} + {H}_{0} )\end{matrix} ) \\ {θ}_{1} = {sin}^{- 1} ( \frac{2 {α}_{1} Im ( {h}_{0}^{*} {h}_{1} {h}_{2} {h}_{3}^{*} )}{\vert \begin{matrix}{h}_{2}^{*} {h}_{3} ( \begin{matrix}{α}_{1}^{2} {J}_{1} + \\ {H}_{2}\end{matrix} ) - \\ {h}_{0}^{*} {h}_{1} ( \begin{matrix}{α}_{1}^{2} {J}_{3} + \\ {J}_{0}\end{matrix} )\end{matrix} \vert} ) - φ ( \begin{matrix}{h}_{2}^{*} {h}_{3} ( {α}_{1}^{2} {J}_{1} + {J}_{2} ) - \\ {h}_{0}^{*} {h}_{1} ( {a}_{1}^{2} {J}_{3} + {J}_{0} )\end{matrix} ) \qquad ( 11 )$$

Here, Φ(c) is the phase of a complex number c.

Also, since c₁=βc₀ and

$$\frac{B}{A} = \frac{D}{C}$$

or AD=BC, β may be rewritten as follows.

$$β = \sqrt{\frac{\begin{matrix}( {h}_{0} + {h}_{1} {α}_{0} {e}^{{jθ}_{0}} ) {( {h}_{0} + {h}_{1} {α}_{0} {e}^{{jθ}_{0}} )}^{*} \\ \{ ( {h}_{2} + {h}_{3} {α}_{0} {e}^{{jθ}_{0}} ) {( {h}_{2} + {h}_{3} {α}_{0} {e}^{{jθ}_{0}} )}^{*} + ( 1 + {α}_{0}^{2} ) {σ}_{1}^{2} \}\end{matrix}}{\begin{matrix}( {h}_{2} + {h}_{3} {α}_{1} {e}^{{jθ}_{1}} ) {( {h}_{2} + {h}_{3} {α}_{1} {e}^{{jθ}_{1}} )}^{*} \\ \{ ( {h}_{0} + {h}_{1} {α}_{1} {e}^{{jθ}_{1}} ) {( {h}_{0} + {h}_{1} {α}_{1} {e}^{{jθ}_{1}} )}^{*} + ( 1 + {α}_{1}^{2} ) {σ}_{0}^{2} \}\end{matrix}}} \qquad ( 12 )$$

At this time, if c₀²+c₁²+c₂²+c₃²=2 is set, the following results are calculated.

$$\begin{matrix}{c}_{0} = \sqrt{\frac{{c}_{0 , ini}^{2} + {c}_{1 , ini}^{2}}{1 + {β}^{2}}} & {c}_{1} = β \sqrt{\frac{( {c}_{0 , ini}^{2} + {c}_{1 , ini}^{2}}{1 + {β}^{2}}} \\ {c}_{1 , ini} = \frac{1}{1 + {α}_{1}^{2}} & {c}_{0 , ini} = \frac{1}{1 + {α}_{0}^{2}}\end{matrix} \qquad ( 13 )$$

Accordingly, through the above-described processing, the coefficients of the precoder 100 are calculated as follows.

$$\begin{matrix}{c}_{0} = \sqrt{\frac{{c}_{0 , ini}^{2} + {c}_{1 , ini}^{2}}{1 + {β}^{2}}} & {c}_{1} = β \sqrt{\frac{( {c}_{0 , ini}^{2} + {c}_{1 , ini}^{2}}{1 + {β}^{2}}}\end{matrix} \\ \begin{matrix}{c}_{2} = {α}_{0} {c}_{0} {e}^{{jθ}_{0}} & {c}_{3} = {α}_{1} {c}_{1} {e}^{{jθ}_{1}}\end{matrix} \qquad ( 14 )$$

FIG. 5 is a more detailed view of the multi-user, multi-antenna, wireless transmission/reception system including the precoder 100 according to an exemplary embodiment. As illustrated in FIG. 5, a multi-antenna, wireless transmission apparatus includes a channel characteristic acquiring unit 300 to acquire characteristic parameters of a wireless transmission channel between a transmitting party antenna and a receiving party antenna, a coefficient calculator 500 to use functions of the characteristic parameters of the wireless transmission channel to calculate coefficients configured such that the transmitting party sets a ratio of received power for a transmission signal at the receiving party to intensity of interference and noise of the transmission signal, and the precoder 100 to multiply an input signal by a matrix whose elements are the coefficients calculated by the coefficient calculator 500, and to output the product. For example, a transmitting party may maximize a ratio of received power for a transmission signal at a receiving party to intensity of interference and noise of the transmission signal.

The coefficient calculator 500 includes a multiplication factor calculator 510 to calculate an inter-column multiplication factor and an inter-row multiplication factor, a first coefficient calculator 530 to calculate a first coefficient of the matrix using a function of the characteristic coefficients of the wireless transmission channel; and a matrix calculator 550 to calculate the remaining coefficients of the matrix, by multiplying the first coefficient by the inter-column multiplication factor, multiplying the first coefficient by the inter-row multiplication factor, and multiplying the first coefficient by the inter-column multiplication factor and the inter-row multiplication factor. For example, the matrix calculator 550 may calculate the last coefficient of the matrix by multiplying the first coefficient by the first inter-row multiplication factor and the inter-column multiplication factor or the inter-column multiplication factor and the second inter-row multiplication factor in order.

The channel characteristic acquiring unit 300 acquires channel characteristic parameters at time intervals, which may be regularly set, so that a transmission terminal of a base station communicates with receiving terminals present in cells. The multiplication factor calculator 510 calculates the inter-column and inter-row multiplication factors shown in FIG. 4. The first coefficient calculator 530 calculates a value of c₀ among four elements of the matrix. The matrix calculator 550 calculates values of the remaining elements of the matrix by multiplying the c₀ value by the inter-column and/or inter-row multiplication factors as explained to above.

The precoder 100 processes input signals with the precoding matrix and transmits the resultant signals through the transmission terminal.

The above-described embodiments have been implemented based on a MIMO system with two transmission antennas to transmit information to two users, but the present invention is not limited to this system as shown and described. It will be understood by those skilled in the art that by using the method proposed in this specification, a precoder can be easily implemented to be applied to a general MIMO system of transmitting signals to 1 through N users through N transmission antennas or in other systems where a precoder is implemented.

This application is further related to the U.S. patent application having attorney docket number P2921US00, which claims priority from and the benefit of Korean Patent Application No. 10-2009-22357, filed on Mar. 16, 2009. Both of these applications, assigned to the assignee of the current application, are hereby incorporated by reference for all purposes as if fully set forth herein.

While the exemplary embodiments have been shown and described, it will be understood by those skilled in the art that various changes in form and details may be made thereto without departing from the spirit and scope of this disclosure as defined by the appended claims and their equivalents. Thus, as long as modifications fall within the scope of the appended claims and their equivalents, they should not be misconstrued as a departure from the scope of the invention itself.

What is claimed is:

1. A precoder for a wireless transmission terminal based on a Multiple-Input and Multiple-Output (MIMO) scheme, the precoder to multiply an input signal by a matrix, and to output the product for wireless transmission, the precoder matrix having coefficients configured such that a transmitting party sets a ratio of received power for a transmission signal at a receiving party to intensity of interference and noise of the transmission signal.

2. The precoder of claim 1, applied to a 2×2 MIMO system, wherein the coefficients of the precoder are:
$$[ \begin{matrix}{c}_{0} & {c}_{1} \\ {c}_{2} & {c}_{3}\end{matrix} ] ,$$
wherein c0 is a first coefficient of the matrix determined using characteristic parameters of a wireless transmission channel between a transmitting party antenna and a receiving party antenna, c1 is determined as a product of the first coefficient and an inter-column multiplication factor, c2 is determined as a product of the first coefficient and a first inter-row multiplication factor, and c3 is determined as a product of the first coefficient, the inter-column multiplication factor, and one of the first inter-row multiplication factor and a second inter-row multiplication factor.

3. The precoder of claim 2, wherein c₁=β×c₀, c₂=α₀e^{jθ0}×c₀, and c₃×α₁e^{jθ1}×c₁, β is the inter-column multiplication factor, α₀e^{jθ0} is the first inter-row multiplication factor, and α₁e^{jθ1} is the second inter-row multiplication factor.

4. The precoder of claim 3, wherein,
$$β = \sqrt{\frac{\begin{matrix}( {h}_{0} + {h}_{1} {α}_{0} {e}^{{jθ}_{0}} ) {( {h}_{0} + {h}_{1} {α}_{0} {e}^{{jθ}_{0}} )}^{*} \\ \{ ( {h}_{2} + {h}_{3} {α}_{0} {e}^{{jθ}_{0}} ) {( {h}_{2} + {h}_{3} {α}_{0} {e}^{{jθ}_{0}} )}^{*} + ( 1 + {α}_{0}^{2} ) {σ}_{1}^{2} \}\end{matrix}}{\begin{matrix}( {h}_{2} + {h}_{3} {α}_{1} {e}^{{jθ}_{1}} ) {( {h}_{2} + {h}_{3} {α}_{1} {e}^{{jθ}_{1}} )}^{*} \\ \{ ( {h}_{0} + {h}_{1} {α}_{1} {e}^{{jθ}_{1}} ) {( {h}_{0} + {h}_{1} {α}_{1} {e}^{{jθ}_{1}} )}^{*} + ( 1 + {α}_{1}^{2} ) {σ}_{0}^{2} \}\end{matrix}}} , \\ {c}_{0} = \sqrt{\frac{{c}_{0 , ini}^{2} + {c}_{1 , ini}^{2}}{1 + {β}^{2}}} , \begin{matrix}{c}_{1 , ini} = \frac{1}{1 + {α}_{1}^{2}} & {c}_{0 , ini} = \frac{1}{1 + {α}_{0}^{2}}\end{matrix} , \\ {a}_{0} = \sqrt{\frac{( {h}_{2}^{*} {h}_{3} {H}_{0} - {h}_{0}^{*} {h}_{1} {H}_{2} ) ( 1 - C )}{( {h}_{2}^{*} {h}_{3} {H}_{3} - {h}_{0}^{*} {h}_{1} {H}_{1} ) ( 1 + C )}} , \\ {a}_{1} = \sqrt{\frac{( {h}_{0}^{*} {h}_{1} {J}_{0} - {h}_{2}^{*} {h}_{3} {J}_{2} ) ( 1 - T )}{( {h}_{0}^{*} {h}_{1} {J}_{3} - {h}_{2}^{*} {h}_{3} {J}_{1} ) ( 1 + T )}} , \\ C = \frac{{H}_{2} {H}_{3} - {H}_{3}^{2} - {σ}_{1}^{2} {H}_{0}}{2 Im ( {h}_{0}^{*} {h}_{1} {h}_{2} {h}_{3}^{*} )} , T = \frac{{J}_{2} {J}_{3} - {J}_{3}^{2} - {σ}_{0}^{2} {J}_{0}}{2 Im ( {h}_{0}^{*} {h}_{1} {h}_{2} {h}_{3}^{*} )} , \\ {θ}_{0} = {sin}^{- 1} ( \frac{2 {α}_{0} Im ( {h}_{0}^{*} {h}_{1} {h}_{2} {h}_{3}^{*} )}{\vert \begin{matrix}{h}_{0}^{*} {h}_{1} ( \begin{matrix}{α}_{0}^{2} {H}_{1} + \\ {H}_{2}\end{matrix} ) - \\ {h}_{2}^{*} {h}_{3} ( \begin{matrix}{α}_{0}^{2} {H}_{3} + \\ {H}_{0}\end{matrix} )\end{matrix} \vert} ) - φ ( \begin{matrix}{h}_{0}^{*} {h}_{1} ( {α}_{0}^{2} {H}_{1} + {H}_{2} ) - \\ {h}_{2}^{*} {h}_{3} ( {a}_{0}^{2} {H}_{3} + {H}_{0} )\end{matrix} ) , \\ {θ}_{1} = {sin}^{- 1} ( \frac{2 {α}_{1} Im ( {h}_{0}^{*} {h}_{1} {h}_{2} {h}_{3}^{*} )}{\vert \begin{matrix}{h}_{2}^{*} {h}_{3} ( \begin{matrix}{α}_{1}^{2} {J}_{1} + \\ {H}_{2}\end{matrix} ) - \\ {h}_{0}^{*} {h}_{1} ( \begin{matrix}{α}_{1}^{2} {J}_{3} + \\ {J}_{0}\end{matrix} )\end{matrix} \vert} ) - φ ( \begin{matrix}{h}_{2}^{*} {h}_{3} ( {α}_{1}^{2} {J}_{1} + {J}_{2} ) - \\ {h}_{0}^{*} {h}_{1} ( {a}_{1}^{2} {J}_{3} + {J}_{0} )\end{matrix} ) ,$$
Φ(c) is the phase of a complex number c,
H₀=h₀h₀* H₁=h₃h₃*+σ₁² H₂=σ₁²+h₂h₂* H₃=h₃h₃*
J₀=h₂h₂* J₁=h₁h₁*+σ₀² J₂=σ₀²+h₀h₀* J₃=h₁h₁* and
wherein transmission and reception relation is expressed as:
$$\begin{matrix}R & = & H & C & S & + & N \\ ( \begin{matrix}{r}_{0} \\ {r}_{1}\end{matrix} ) & = & ( \begin{matrix}{h}_{0} & {h}_{1} \\ {h}_{2} & {h}_{3}\end{matrix} ) & ( \begin{matrix}{c}_{0} & {c}_{1} \\ {c}_{2} & {c}_{3}\end{matrix} ) & ( \begin{matrix}{s}_{0} \\ {s}_{1}\end{matrix} ) & + & ( \begin{matrix}{η}_{0} \\ {η}_{1}\end{matrix} )\end{matrix}$$

5. The precoder of claim 1, wherein the precoder matrix has coefficients configured such that a transmitting party maximizes a ratio of received power for a transmission signal at a receiving party to intensity of interference and noise of the transmission signal.

6. A multi-antenna, wireless transmission apparatus, comprising:
a channel characteristic acquiring unit to acquire characteristic parameters of a wireless transmission channel between a transmitting party antenna and a receiving party antenna;
a coefficient calculator to use the characteristic parameters of the wireless transmission channel to calculate coefficients configured such that the transmitting party sets a ratio of received power for a transmission signal at the receiving party to intensity of interference and noise of the transmission signal; and
a precoder to multiply an input signal by a matrix whose elements are the coefficients calculated by the coefficient calculator, and to output the product for transmission to the receiving party antenna.

7. The multi-antenna, wireless transmission apparatus of claim 6, wherein the coefficient calculator comprises:
a multiplication factor calculator to calculate an inter-column multiplication factor and an inter-row multiplication factor;
a first coefficient calculator to calculate a first coefficient of the matrix using the characteristic parameters of the wireless transmission channel; and
a matrix calculator to calculate the remaining coefficients of the matrix by multiplying the first coefficient by the inter-column multiplication factor, multiplying the first coefficient by the inter-row multiplication factor, and multiplying the first coefficient by the inter-column multiplication factor and the inter-row multiplication factor, respectively.

8. The multi-antenna, wireless transmission apparatus of claim 6, wherein the coefficients are configured such that the transmitting party maximizes a ratio of received power for a transmission signal at the receiving party to intensity of interference and noise of the transmission signal.

9. The multi-antenna, wireless transmission apparatus of claim 6, wherein the coefficients are:
$$[ \begin{matrix}{c}_{0} & {c}_{1} \\ {c}_{2} & {c}_{3}\end{matrix} ] ,$$
wherein c0 is a first coefficient of the matrix determined using the characteristic parameters of the wireless transmission channel, c1 is determined as a product of the first coefficient and an inter-column multiplication factor, c2 is determined as a product of the first coefficient and a first inter-row multiplication factor, and c3 is determined as a product of the first coefficient, the inter-column multiplication factor, and one of the first inter-row multiplication factor and a second inter-row multiplication factor.

10. A method for transmitting a transmission signal from a wireless transmission terminal based on a Multiple-Input and Multiple-Output (MIMO) scheme, comprising:
acquiring characteristic parameters of a transmission channel between a transmitting party antenna and a receiving party antenna;
calculating coefficients configured such that a transmitting party sets a ratio of received power for a transmission signal at a receiving party to intensity of interference and noise of the transmission signal;
multiplying an input signal by a matrix whose elements are the coefficients to generate an output signal; and
outputting the output signal for transmission from the transmitting party antenna to the receiving party antenna.

11. The method of claim 10, wherein calculating the coefficients further comprises:
calculating an inter-column multiplication factor and an inter-row multiplication factor;
calculating a first coefficient the coefficients using the characteristic parameters of the transmission channel; and
calculating the remaining coefficients by multiplying the first coefficient by the inter-column multiplication factor, multiplying the first coefficient by the inter-row multiplication factor, and multiplying the first coefficient by the inter-column multiplication factor and the inter-row multiplication factor, respectively.

12. The method of claim 10, wherein the coefficients are configured such that a transmitting party maximizes a ratio of received power for a transmission signal at a receiving party to intensity of interference and noise of the transmission signal.

13. The method of claim 10, wherein the coefficients are:
$$[ \begin{matrix}{c}_{0} & {c}_{1} \\ {c}_{2} & {c}_{3}\end{matrix} ] ,$$
wherein c0 is a first coefficient of the matrix determined using the characteristic parameters of the transmission channel, c1 is determined as a product of the first coefficient and an inter-column multiplication factor, c2 is determined as a product of the first coefficient and a first inter-row multiplication factor, and c3 is determined as a product of the first coefficient, the inter-column multiplication factor, and one of the first inter-row multiplication factor and a second inter-row multiplication factor.
